(19) United States
(12) Patent Application Publication
(10) Pub. No.: US 2019/0270264 A1
(43) Pub. Date: Sep. 5, 2019

(54) METHOD FOR PREPARING RIGID CORNEAL CONTACT LENSES

(71) Applicants: HAICHANG CONTACT LENSES CO., LTD., ZHENJIANG CITY (CN); JIANGSU HAILUN CONTACT LENSES CO., LTD., ZHENJIANG CITY (CN)

(72) Inventors: PING CHEN, ZHENJIANG CITY (CN); YONG JIANG, ZHENJIANG CITY (CN)

(21) Appl. No.: 16/094,259

(22) PCT Filed: Feb. 25, 2017
(86) PCT No.: PCT/CN2017/074843

§ 371 Date: Oct. 17, 2018

(30) Foreign Application Priority Data
Nov. 18, 2016 (CN) 201611015876.9

(51) Int. Cl. B29D 11/00; B29C 33/38

(52) U.S. Cl. CPC B29D 11/00038; G02C 7/04; B29C 33/3842

(57) ABSTRACT

A method for preparing rigid corneal contact lenses, comprising: designing a lens mold in advance, using a high oxygen permeability siloxane material to react with other polymeric monomers, directly preparing lenses under photocuring or thermocuring processing conditions, and then using the mold to shape in one step. The method can improve the productivity and solve the problems of long processing cycle, low productivity and poor reproducibility of the traditional turning process.

### TECHNICAL FIELD

The invention relates to preparing contact lenses, which pertains to the technical field of polymer materials, and particularly to a method for preparing rigid corneal contact lenses.

### BACKGROUND

Contact lenses, also known as corneal contact lenses, are lenses that are worn directly on the human eye and used primarily to correct vision. The lens material developed earliest is polymethylmethacrylate, which pertains to rigid contact lenses. And due to the drawbacks of its relatively stiff material, easily causing corneal abrasion, poor wettability, low oxygen permeability and the like, and easily causing eyeball discomfort when worn, it has been basically eliminated.

In order to solve the problem of oxygen supply, scientists have been working on developing an oxygen permeable material that can directly transfer oxygen from the air to the eyeball. Silicone rubber materials are gradually applied to corneal contact lenses.

The current rigid corneal contact lenses are prepared by high precision lathe, with long processing cycle, low productivity, and poor repeatability. The method of the present invention can be standardized and industrialized, by utilizing compression molding production technology, pre-designing the lens mold, one-step forming using the mold, and thus greatly improving the production capacity of the product.

### SUMMARY

The object of the present invention is to provide a method for preparing rigid corneal contact lenses, to solve the technical problem.

A method for preparing rigid corneal contact lenses, comprises the following steps:

A. Mold design and processing: designing the lens parameters required for rigid corneal contact lenses, and using precision lathe to process the molds required for the lenses;

B. Preparation of a polymeric material of rigid corneal contact lenses; pretreating a polysiloxane material as a host material with other monomers or compounds, and the pretreatment comprises mixing, pre-polymerizing or grafting;

C. Compression molding of rigid corneal contact lenses: using the designed mold with the rigid corneal contact lenses product parameters, the required lenses are formed by polymerization reaction under photocuring or thermocuring condition;

D. Subsequent processing: a combination of one or more steps in mold opening, cleaning, testing, packaging, and disinfection.

Preferably, the mold materials in step A comprise materials such as metal, plastic, glass, crystal and the like, the mold preparing in step A can first manufacture the metal mold, and then manufacture into any one of plastic, glass, and crystal by the injection molding method.

Preferably, in step B, the siloxane material refers to a class of polymers in which a repeating Si—O bond is the main chain and a silicon atom is directly bonded to an organic group, and their oxygen permeability coefficient is typically greater than 145×10⁻¹¹ (cm²/s) [mLO²/(mL×hPa)], or even greater.

Preferably, the other monomers or compounds described in step B refer to a crosslinking agent and an initiator required for the reaction.

Preferably, the crosslinking agent may be one of the materials such as polyethylene glycol diacrylate, ethylene glycol dimethacrylate and triallyl isocyanurate, or any combination thereof.

Preferably, the initiator may be a photoinitiator or a thermal initiator, and the photoinitiator is one of the photoinitiators such as 2-hydroxy-2-methylpropiophenone and benzoin methyl ether, or a combination thereof; the thermal initiator is one of the thermal initiators such as azobisisobutyronitrile and benzoyl peroxide, or a combination thereof.

Preferably, the subsequent processing further comprises processing that may be performed on the size and appearance of the lenses.

The invention has the following beneficial effects: the method for preparing rigid corneal contact lenses of the invention, comprising: designing a lens mold in advance, using siloxane materials to react with other polymeric monomers, using the mold to directly prepare lenses in one step under photocuring or thermocuring processing conditions, and the method can greatly improve the productivity and solve the problems of long processing cycle, low productivity and poor reproducibility of the traditional turning process.

The present invention has further objects, features and advantages among the objects, features and advantages described above. The invention will be described in further detail below.

### DETAILED DESCRIPTION OF THE EMBODIMENTS

The embodiments of the present invention are described in detail below, but the present invention may be implemented in various different ways as defined and covered in the following claims.

### EXAMPLE 1

A method for preparing rigid corneal contact lenses, comprising the following steps:

A. Mold design and processing: designing the lens parameters required for rigid corneal contact lenses, and using precision lathe to process the mold required for the lenses;

B. Preparation of a polymeric material of rigid corneal contact lenses; pretreating a polysiloxane material as a host material with other monomers or compounds, and the pretreatment comprises mixing, pre-polymerizing or grafting;

C. Compression molding of rigid corneal contact lenses: using the designed mold with the rigid corneal contact lenses product parameters, the required lenses are formed by polymerization reaction under photocuring or thermocuring condition;

D. Subsequent processing: a combination of one or more steps in mold opening, cleaning, testing, packaging, and disinfection.

The mold material of step A is crystal.

In step B, the siloxane material refers to a class of polymers in which a repeating Si—O bond is the main chain and a silicon atom is directly bonded to an organic group, and their oxygen permeability coefficient is greater than 145×10⁻¹¹ (cm²/s) [mLO²/(mL×hPA)].

The other monomers or compounds in step B refer to a crosslinking agent and an initiator required for the reaction.

The crosslinking agent is polyethylene glycol diacrylate.

The initiator is a photoinitiator, and the photoinitiator is 2-hydroxy-2-methylpropiophenone.

The subsequent processing further comprises processing that may be performed on the size and appearance of the lenses.

### EXAMPLE 2

A method for preparing rigid corneal contact lenses, comprising the following steps:

A. Mold design and processing: designing the lens parameters required for rigid corneal contact lenses, and using precision lathe to process the mold required for the lenses;

B. Preparation of a polymeric material of rigid corneal contact lenses; pretreating a polysiloxane material as a host material with other monomers or compounds, and the pretreatment comprises mixing, pre-polymerizing or grafting;

C. Compression molding of rigid corneal contact lenses: using the designed mold with the rigid corneal contact lenses product parameters, the required lenses are formed by polymerization reaction under photocuring or thermocuring condition;

D. Subsequent processing: a combination of one or more steps in mold opening, cleaning, testing, packaging, and disinfection.

The mold material in step A is PP plastic, and the metal mold is processed first, and the plastic mold is produced by injection molding method.

In step B, the siloxane high oxygen permeability material refers to a class of polymers in which a repeating Si—O bond is the main chain and a silicon atom is directly bonded to an organic group, and their oxygen permeability coefficient is greater than 145×10^{31 11} (cm²/s) [mLO²/(mL×hPa)].

The other monomers or compounds in step B refer to a crosslinking agent and an initiator required for the reaction.

The crosslinking agent may be a combination of ethylene glycol dimethacrylate and polyethylene glycol diacrylate.

The initiator is a photoinitiator, and the photoinitiator is benzoin methyl ether.

The subsequent processing further comprises processing that may be performed on the size and appearance of the lenses.

### EXAMPLE 3

A method for preparing rigid corneal contact lenses, comprising the following steps:

A. Mold design and processing: designing the lens parameters required for rigid corneal contact lenses, and using precision lathe to process the mold required for the lenses;

B. Preparation of a polymeric material of rigid corneal contact lenses; pretreating a polysiloxane material as a host material with other monomers or compounds, and the pretreatment comprises in mixing, pre-polymerizing or grafting;

C. Compression molding of rigid corneal contact lenses: using the designed mold with the rigid corneal contact lenses product parameters, the required lenses are formed by polymerization reaction under photocuring or thermocuring condition;

D. Subsequent processing: a combination of one or more steps in mold opening, cleaning, testing, packaging, and disinfection.

The mold material in step A is PBT plastic, the metal mold is processed first, and the mold is produced by injection molding method.

In step B, the siloxane high oxygen permeability material refers to a class of polymers in which a repeating Si—O bond is the main chain and a silicon atom is directly bonded to an organic group, and their oxygen permeability coefficient is greater than 145×10⁻¹¹ (cm²/s) [mLO²/(mL×hPa)].

The other monomers or compounds in step B refer to a crosslinking agent and an initiator required for the reaction.

The crosslinking agent may be polyethylene glycol diacrylate and isocyanuric acid triallyl ester.

The initiator is a thermal initiator; the thermal initiator is azobisisobutyronitrile.

The subsequent processing further comprises processing that may be performed on the size and appearance of the lenses.

The description above is only the preferred embodiment of the present invention, and is not intended to limit the present invention, and various modifications and alterations of the present invention are readily recognized by those skilled in the art. Any modifications, equivalent substitutions, improvements and the like made within the spirit and scope of the present invention are within the scope of the present invention.

1. A method for preparing rigid corneal contact lenses, comprising the following steps:
A. Mold design and processing: designing lens parameters required for the rigid corneal contact lenses, and using precision lathe to process the mold required for the lenses;
B. Preparation of a polymeric material of the rigid corneal contact lenses; pretreating a polysiloxane material as a host material with other monomers or compounds, and the pretreatment comprises mixing, pre-polymerizing or grafting;
C. Compression molding of the rigid corneal contact lenses: using the designed mold with the rigid corneal contact lenses product parameters, the required lenses are formed by polymerization reaction under photocuring or thermocuring condition;
D. Subsequent processing: a combination of one or more steps in mold opening, cleaning, testing, packaging, and disinfection.

2. The method for preparing the rigid corneal contact lenses of claim 1, wherein the mold materials in step A comprise any one of metal, plastic, glass, crystal.

3. The method for preparing the rigid corneal contact lenses of claim 2, wherein the mold preparing in step A including: first manufacturing metal mold, and then manufacturing into any one of plastic, glass, and crystal by injection molding method.

4. The method for preparing the rigid corneal contact lenses of claim 1, wherein in step B, the siloxane material refers to a class of polymers in which a repeating Si—O bond is a main chain, and a silicon atom is directly bonded to an organic group; their oxygen permeability coefficient is greater than 145 ×10⁻¹¹ (cm²/s).

5. The method for preparing the rigid corneal contact lenses of claim 1, wherein the other monomers or compounds in step B refer to a crosslinking agent and an initiator required for the reaction.

6. The method for preparing the rigid corneal contact lenses of claim 5, wherein the crosslinking agent may be one of polyethylene glycol diacrylate, ethylene glycol dimethacrylate and triallyl isocyanurate, or any combination thereof.

7. The method for preparing the rigid corneal contact lenses of claim 5, wherein the initiator may be a photoinitiator or a thermal initiator.

8. The method for preparing the rigid corneal contact lenses of claim 7, wherein the photoinitiator is one of 2-hydroxy-2-methylpropiophenone and benzoin methyl ether, or a combination of two thereof.

9. The method for preparing the rigid corneal contact lenses of claim 7, wherein the thermal initiator is one of azobisisobutyronitrile and benzoyl peroxide, or a combination of two thereof.

10. The method for preparing the rigid corneal contact lenses of claim 1, wherein the subsequent processing further comprises processing performed on the size and appearance of the lenses.
